(19) United States
(12) Patent Application Publication
(10) Pub. No.: US 2009/0295578 A1
(43) Pub. Date: Dec. 3, 2009

(54) Portable security system and method thereof

(76) Inventor: Kenneth Gantt, Advance, NC (US)

Correspondence Address: JAMES RAY & ASSOCIATES, 2640 PITCAIRN ROAD, MONROEVILLE, PA, 15146, US

(21) Appl. No.: 11/891,184

(22) Filed: Aug. 9, 2007

Related U.S. Application Data
(60) Provisional application No. 60/836,743, filed on Aug. 10, 2006.

(51) Int. Cl. G08B 13/20

(52) U.S. Cl. 340/544; 340/541

(57) ABSTRACT

A portable security system for detecting and annunciating intrusion into enclosed confines includes a hollow enclosure and a frame which is engageable with the hollow enclosure for concealing it from direct view. A controller is mounted within the hollow enclosure and is operably coupled to a source capable of supplying electrical power. A pressure sensor is mounted within the hollow enclosure in electric communication with the controller and is operable to generate an intrusion signal upon detecting an intrusion condition into such enclosed confines, whereby the controller, when being armed, is responsive to receipt of the generated intrusion signal to generate an annunciation signal annunciating the intrusion condition.

### CROSS-REFERENCE TO RELATED APPLICATIONS

This application is related to and claims priority from Provisional Patent Application Ser. No. 60/836,743 filed Aug. 10, 2006.

### FIELD OF THE INVENTION

The present invention relates, in general, to security alarm systems and, more particularly, this invention relates to a portable security system for use in a residence, boat, automobile, office, or any other enclosed confines which senses major changes in air pressure to trigger an alarm.

### BACKGROUND OF THE INVENTION

As is generally well known, conventional household burglar alarm systems are costly to install due to the laborious effort to install magnetically operable sensors on each window and door and connecting all sensor to a local processing unit. The local processing unit is connected, usually over a phone connection, with the main network server that monitor status of such local processing unit and that can detect trigger of the alarm system and inform security response personnel. Thus, owners of such alarm systems pay periodic maintenance and/or monitoring fees which increase the overall cost of ownership. Furthermore, burglars are known to cut the telephone wires prior to entering the premises thus rendering many conventional alarm systems useless. Additionally, since the conventional alarm system is permanently installed, it does not offer any value to the original purchaser who moves to a new property and who is burdened with the installation costs of a new household burglar alarm system.

Motion detection or infrared detection type household burglar alarm systems alleviate the need to secure every window and door but may be inconvenient to those having pets that can inadvertently trigger the alarm or to owners who forget to disarm the motion or infrared detection system prior to entering monitored space. Furthermore, neither motion detection nor infrared detection type household burglar alarm system is capable of detecting broken window or open door.

Another type of the security alarm system which is capable of detecting broken window or open door utilizes air pressure sensor which generates an electrical signal in response to changes in the air pressure within an enclosed area. U.S. Pat. No. 5,691,6697 issued to Carvalho et al.; U.S. Pat. No. 3,990,068 issued to Schuman and U.S. Pat. No. 5,185,593 issued to DuRand et al. disclose various constructions of the security system utilizing air pressure change detectors.

However, there is a continuing need for an improved security system utilizing air pressure change detectors.

### SUMMARY OF THE INVENTION

The invention provides a portable security system for detecting and annunciating intrusion into enclosed confines. The system includes a hollow enclosure. The enclosure has a predetermined shape and a predetermined size. There is means which is engageable with the hollow enclosure for concealing the hollow enclosure from direct view. A control means is mounted within the hollow enclosure and is operably coupled to a source capable of supplying electrical power. A sensor is mounted within the hollow enclosure in electric communication with the control means. The sensor is operable to generate an intrusion signal upon detecting an intrusion condition into such enclosed confines. The control means, when being armed, is responsive to receipt of the generated intrusion signal to generate an annunciation signal annunciating the intrusion condition.

The present invention also provides a method of detecting and annunciating intrusion into enclosed confines by using a sensor capable of detecting air pressure changes and essentially concealing such sensor from direct view.

### OBJECTS OF THE INVENTION

It is, therefore, one of the primary objects of the present invention to provide a portable security system.

Another object of the present invention is to provide a portable security system which senses changes in air pressure to trigger an alarm.

Yet another object of the present invention is to provide a portable security system which is concealed from direct view.

A further object of the present invention is to provide a portable security system which can be remotely armed and disarmed by the user.

Yet a further object of the present invention is to provide a portable security system which can communicate intruder detection condition over a wired or wireless telephone network.

An additional object of the present invention is to provide a portable security system which is simple to install.

Another object of the present invention is to provide a portable security system which can insure continuous protection even in the absence of power in the area to be secured.

A further object of the present invention is to provide a method of detecting intrusion condition by using the portable security system of the present invention.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a portable security system concealed behind a free standing picture frame;

FIG. 2 is a perspective view of a portable security system concealed behind a hanging picture frame;

FIG. 3 is a perspective view of a portable security system concealed behind a book or ring binder cover;

FIG. 4 is a perspective view of a portable security system concealed behind a conventional HVAC system grille;

FIG. 5 is a block diagram of the portable security system;

FIG. 6 is a planar view of a remote controller for at least arming and disarming the portable security system of the present invention; and

FIG. 7 is a block diagram of the remote controller of FIG. 6.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of an enclosed confines applies but is not limited to room or rooms of a residence or office, boat, automobile, article of luggage and any other enclosed structures and articles.

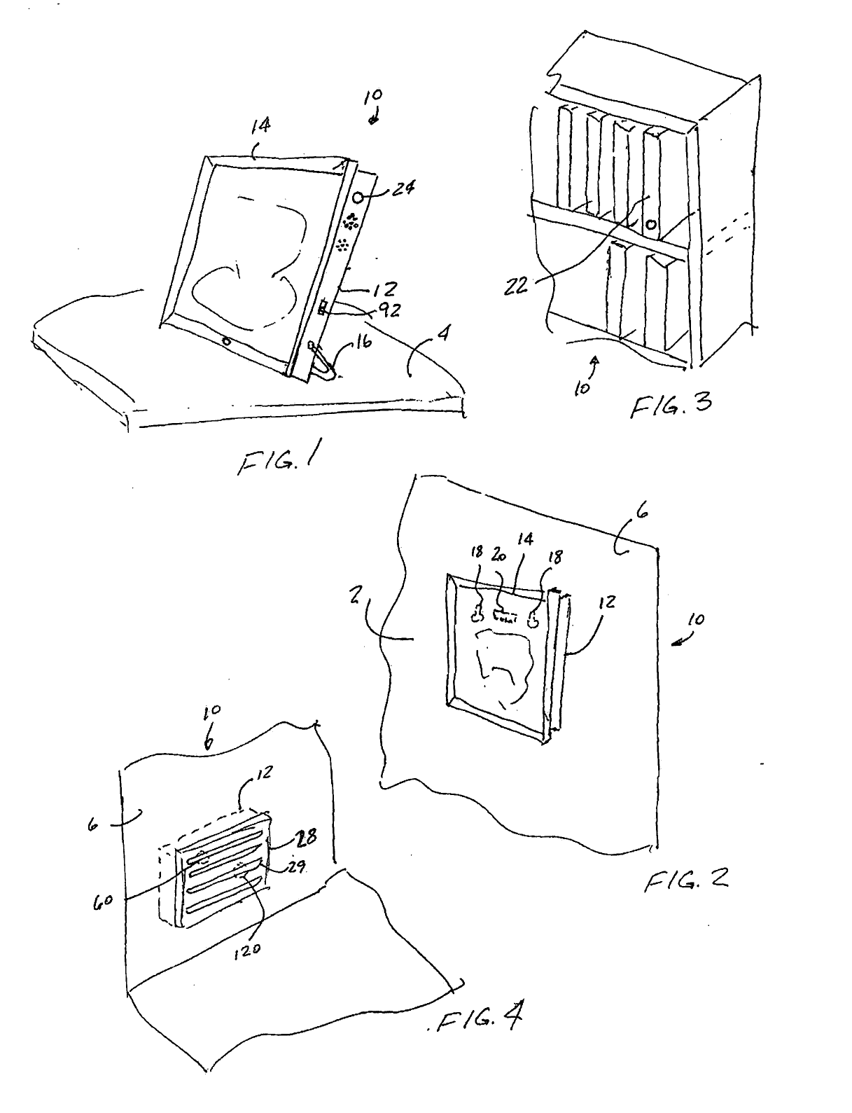

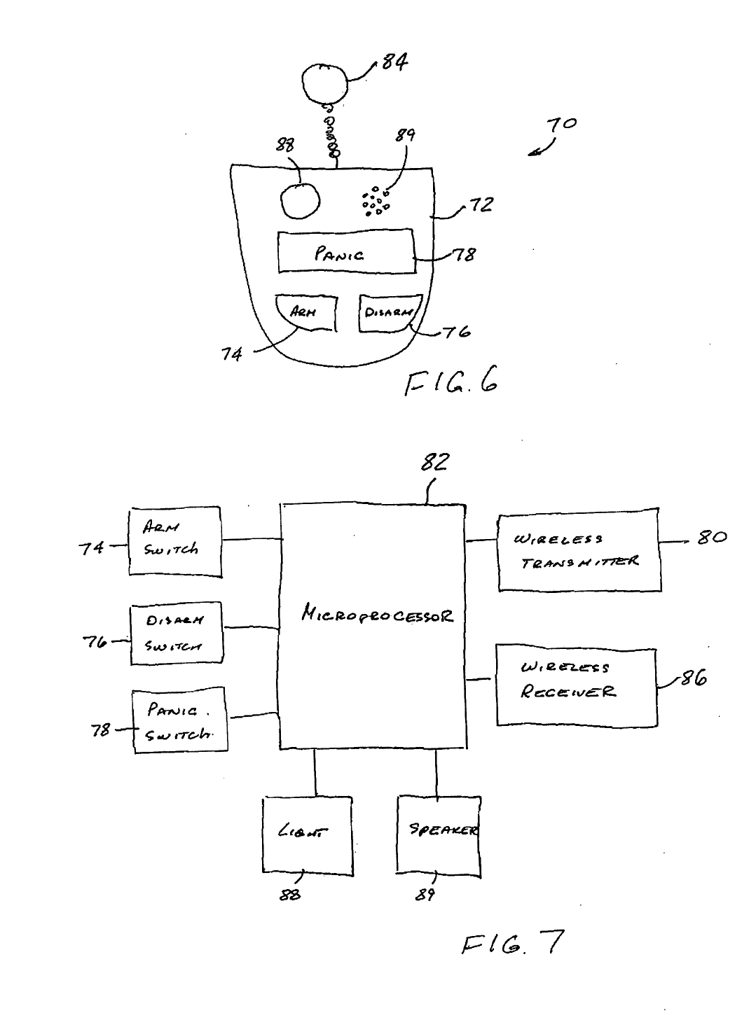

Reference is now made, to FIGS. 1-5, wherein there is shown a portable security system, generally designated as 10, for determining intrusion into an enclosed confines 2, which is partially illustrated and which, by way of an example only, may be a well known room of a residential dwelling. The system 10 includes a hollow enclosure 12 having each of a predetermined shape and a predetermined size. The hollow enclosure 12 can be manufactured from any material and is preferably manufactured from a lightweight plastic. One of the essential elements of the present invention is means for concealing the hollow enclosure 12 from direct view. According to one embodiment of the invention, such enclosure concealing means includes a frame 14 capable of housing a picture, photograph or painting and which is conventionally constructed. The frame 14 is disposed on and secured to a predetermined portion of the hollow enclosure 12. In use, the frame 14 is positioned to be viewed from any entry location into such enclosed confines 2 and conceal the hollow enclosure 12. When the system 10 is to be placed onto a surface 4 in a freestanding fashion, a support 16 is pivotally attached to the back portion of the hollow enclosure 12. However, it will be appreciated that the hollow enclosure 12 may incorporate wall hanging means such as apertures 18 or picture hanging bracket 20 for hanging the system 10 on a wall 6, as best shown in FIG. 2.

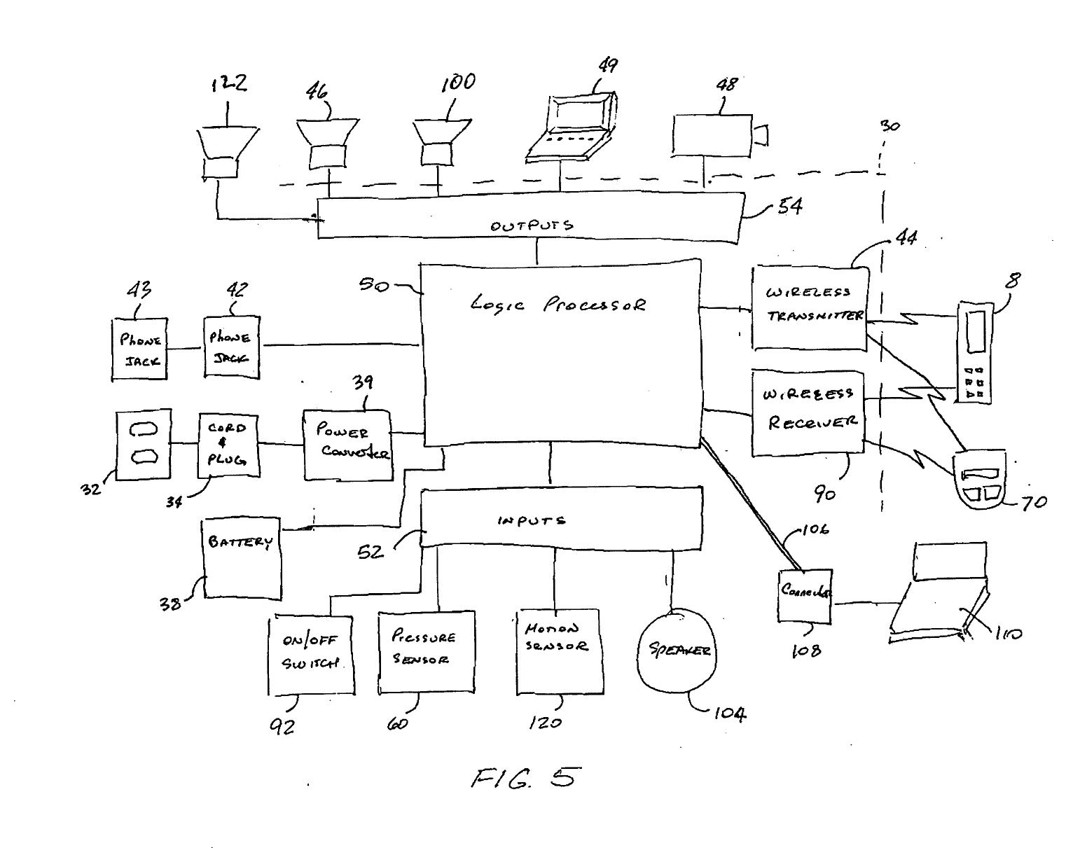

It is also within the scope of the present invention to provide enclosure concealing means as a book or a ring binder cover 22 which can be positioned horizontally on one of its side or vertically on one of its edges, as best shown in FIG. 3.

An orifice 24 is formed in a wall portion of the hollow enclosure 12. There is a control means, generally designated as 30, which is mounted within the hollow enclosure 12 and which is operably coupled to a source capable of supplying electrical power. According to one embodiment, the power supply source is a conventional power electrical outlet 32 and the system further includes means such as a cord and plug set 34 for connecting the control means 30 to the power electrical outlet 32. According to another embodiment, the power supply source is at least one battery 38 which is mounted internal to the hollow enclosure 12. It will be appreciated that the at least one battery 38 may be provided in combination with the cord and plug set 34 as a back-up in situations when the power electrical outlet 32 is not capable of supplying electrical power. It will be also understood that such at least one battery 38 may be of a rechargeable type.

A sensor means 60 is mounted within the hollow enclosure 12 in operable alignment with the orifice 24 and in electrical communication with the control means 30. The sensor means 60 operates to detect an intrusion condition and generate an intrusion signal, whereby the control means 30, when being armed, is responsive to the generated intrusion signal to generate an annunciation signal annunciating the intrusion condition.

In accordance with a presently preferred embodiment of the invention, the sensor means 60 is a pressure sensor capable of generating the intrusion signal due to changes in air pressure within such enclosed confines 2 and wherein the control means 30 is responsive to the receipt of the intrusion signal to generate the annunciation signal. By way of one example only, the pressure sensor 60 may be of a type manufactured by SMARTEC BV of Breda, The Netherlands under the SPD series.

It has been found advantageous, in order to provide sufficient intrusion detection and control overall installation to costs, to employ a pressure sensor of a volumetric type capable of sensing major changes in air pressure within an enclosed confines 2 being in size between about 3500 square feet and about 4500 square feet. Accordingly, by way of another example, the pressure sensor 60 may be of a Veritec P2 type manufactured by Pyronix LTD of Great Britain. Either sensor is capable of detecting major change in air pressure, such as a window breaking or door opening, automatically protecting all entry points into enclosed confines 2 but not restricting movement of occupants or animals inside the enclosed confines 2. The Veritec P2 pressure sensor is capable of monitoring a plurality of rooms within a single dwelling and is immune to presence of walls, stairs and other interior structures and contents. However, it is within the scope of the present invention to use other pressure sensors capable of detecting major air change within closed confines 2 or custom design and manufacture such pressure sensor 60 for specific application.

It will be appreciated that the control means 30 may be adapted to receive either a digital or analog intrusion signal and to generate the annunciation signal which can then be used to perform various tasks. The annunciation signal may be generated as a telephone call over a wired phone connection through the phone plug 42 connected to a phone jack 43 or over a wireless connection through a wireless transmitter means 44, since it may be possible for the intruder to disable the land line telephone connection external to the enclosed confines 2. For example, the control means 30 may be programmed to call a mobile phone 8 of the user of the system 10. Advantageously, such telephone call may be generated as a silent signal as to not worn the potential intruder. Alternatively, or in combination with the telephone call, the system 10 may include at least one speaker means 46 which is triggered by the control means 30 for generating an audible alarm signal. The annunciation signal may be also employed to trigger a video or still camera 48, activate computer 49, turn on and/or flash lights (not shown) and to perform other tasks common in a security system art.

It will be apparent to those skilled in the art that the control means 30 incorporates logic processing means 50, which may be of a microprocessor or programmable logic controller type, for processing various logics upon receiving the intrusion signal and prior to generating annunciation signal. It is presently preferred for the logic processing means 50 to be of the microprocessor type. Furthermore, the control means 30 will include a power converter 39 for converting electrical power received from the outlet 32 into a low voltage direct current (DC) power typically employed to operate microprocessor type controls.

To receive intrusion signal and trigger various devices, the control means 30 also incorporates a plurality of input means 52 and a plurality of output means 54.

In order to arm and disarm operation of the system 10 and, more particularly, receive the intrusion signal generated from the pressure switch 60 by the logic processing means 50, the system 10 includes means for arming and disarming the system 10. In accordance with a presently preferred embodiment of the invention, such arming and disarming means includes a remote controller, generally designated as 70, which is operable by the user for remotely and selectively arming and disarming the system 10. Now in reference to FIGS. 6-7, such remote controller 70 includes a housing 72, a first switch means 74 for generating an arming signal, a second switch means 76 for generating a disarming signal, a third switch means 78 for generating a panic signal, wireless transmitter means 80 for wirelessly transmitting such arming, disarming and panic signals and a microprocessor 82. Preferably, each of the switch means 74, 76 and 78 is of a pushbutton type. The remote controller 70 can be attached, in a conventional manner, to a key chain with a key ring 84.

To use the remote controller 70, the system 10 further includes a wireless receiver means 90 which is operably connected to the logic processing means 50 for receiving each of such wirelessly generated arming, disarming and panic signals and converting them into digital output capable of being received by the logic processing means 50 through one of the input means 52. Such remote controller 70 enables the user to remotely arm and disarm the system 10 and eliminates the need to install a conventional control unit which is directly wired to the logic processing means 50 and which is generally installed at a point of entry into such enclosed confines 2. Thus, the user is capable of arming the system 10 upon leaving the enclosed confines 2 and disarming the system 10 prior to entering the enclosed confines 2. It is also within the scope of the present invention to provide an optional on/off switch 92 which is mounted within the hollow enclosure 12 and which is manually operable by the user to arm or disarm the system 10.

The user may also use the panic switch 78 to activate the at least one speaker means 46 in order to sound the alarm and, accordingly, the logic processing means 50 will be programmed to activate such at least one speaker means 46 upon receiving the panic signal wirelessly transmitted by the remote controller 70 when the user activates the panic switch means 78.

Advantageously, the control means 30 may be programmed to wirelessly transmit the annunciation signal to the remote controller 70 which will include a wireless receiver means 86 for receiving such wirelessly transmitted annunciation signal and a light 88 and/or speaker 89 coupled to the microprocessor 82 for generating respective visual and/or audible signal within the remote controller 70.

It is further within the scope of the present invention to include means for enabling user to silently monitor the enclosed confines 2. Accordingly, the system 10 includes a microphone lob which is operably connected to the logic processing means 50 and which is activated when the user of the system 10 initiates a telephone call from a remote location and enters a predetermined security code. Thus, the user of the system 10 will be capable of verifying the cause of the generated annunciation signal. The present invention also contemplates to include at least one speaker means 104 enabling the user to speak into enclosed confines 2 if necessary.

In order to enable the user to simply program or reprogram the operation of the system 10, there is a RS-485 data bus 106 which is connected to the logic processing means 50 and which is equipped with a conventional 4 wire RJ-11 telephone style connector 108 for connection to a personnel computer 110. Alternatively to or in combination with the RS-485 data bus 106, the control system 30 is adapted for remote programming or reprogramming of the operational settings by way of the phone connection through the jack 42 or through the wireless receiver 90. For example, the user will be capable of using mobile phone 8 to remotely program or reprogram operational settings.

Another speaker means 122 may be provided to annunciate arming or disarming of the system 10 by providing a low tone chirp type sound which can be easily recognized by the user when arming or disarming the system 10. For example, the control means 30 may produce one chirp when arming the system 10 and a pair of chirps when disarming the system 10. This chirp type sound may be also used to indicate low battery condition monitored by the logic processing means 50.

While it has been found that a single pressure sensor means 60 is adequate to detect an intrusion into the enclosed confines 2, it may be desirable in some applications to improve reliability of the system 10 by adding a second sensor means, preferably of a different type. Such sensor may be a well known motion detector sensor 120 which is operably connected to the control means 30 for providing an independent intrusion signal to the logic processing means 50. The control means 30 will then use this independent intrusion signal to verify the intrusion signal received from the pressure sensor 60 prior to generating the intrusion annunciation signal. The signal from the motion detector 120 may be also employed in situations when pressure sensor 60 fails to operate due to a malfunction. Alternatively to the motion detector sensor 120, the system 10 may employ an infrared sensor (not shown).

In operation, the user arms the system 10, preferably using the switch means 74 disposed within the housing 72 of the remote controller 70 upon exiting the enclosed confines 2. When armed, the control means 30 is programmed to receive the intrusion signal from the pressure switch 60. When the intruder enters the enclosed confines 2 by opening a door (not shown) or breaking a window (not shown), the pressure switch 60 detects associated major change in (volumetric) air pressure and generates such intrusion signal. Preferably, the logic processing means 50 is programmed to delay activation of the at least one speaker means 46 or any other connected device for a predetermined period of time in order to alert the user of the system 10 and allow the user to disarm the system 10 by using the remote controller 70. The logic processing means 50 may be also programmed to initiate at least one phone call to a number stored in its memory. Thus, the user can receive a call on the mobile phone 8 and, recognizing the phone number associated with the system 10, enter the predetermined access code. By pressing a predetermined button or entering a predetermined access code on the cell phone keypad, the user can activate the microphone 100 and by pressing another predetermined button or another predetermined access code, the user can activate the at least one speaker means 104. If the user does not hear abnormal noises indicating intruder presence, the user may disarm the system 10 by way of a remote controller 70. If the user detects abnormal noises indicating intruder presence, the user may then activate the at least one speaker means 46 in order to alarm the intruder and may speak into the enclosed confines 2 through the at least one speaker means 104. However, it is within the scope of the present invention to activate the speaker means 46 immediately upon receiving the intrusion signal. If the system 10 has not been disarmed when time delay expires, the logic processing means 50 will activate the at least one speaker means 46 to annunciate an alarm condition.

The present invention contemplates that the panic switch means 78 may be employed independently of the armed or disarmed status of the system 10 at least causing activation of the at least one speaker means 46.

From the embodiments described above it will be apparent to those skilled in the art that the system 10 disguised as an attractive framed picture, painting, photograph, book or ring binder cover enhances security of the enclosed confines 2. Simple installation of the system 10, requiring the user only to connect the system 10 to the phone jack 43 and source of electrical power 32, minimizes installation costs and eliminates annual maintenance costs associated with prior art security systems. The costs are further minimized if the system 10 is to be communicated with in the wireless manner and only employs the at least one battery 38. The user is also enabled to simply unplug the system 10 and transport it to a different location.

Advantageously, the employment of air pressure sensor 60 is immune to and eliminates false activations due pets, the air conditioning coming on, plants blowing in the breeze and the like associated with prior art laser and motion sensors.

Although the present invention has been shown in terms of the system 10 employed for detecting intrusion into a room or building, it will be apparent to those skilled in the art, that the system 10 can be employed for detecting intrusion into boat, automobile, article of luggage and the like enclosed confines.

Various off-the-shelf devices presently employed in the burglar or intruder alarm systems may be employed in the present invention in place of the microprocessor based control means 30 for controlling operation of the system 10. For example, a programmable controller manufactured by ELK Products, Inc. of Hildebran, N.C. under the brand name “Magic Module” and Model Number ELK-MM443 may be employed as a logic processing means 50. This programmable controller 50 is capable of providing four analog or digital inputs as well as four identical relay outputs for triggering various auxiliary devices. It also incorporates RS-485 data bus equipped with a conventional 4 wire RJ-11 telephone style connector for connection to a personnel computer enabling the user ease and simplicity of programming or reprogramming the operation of the system 10. The size of the programmable controller being about 6.5 inches in width, about 4.4 inches in height and about 2.0 inches in height makes it advantageous for mounting within the enclosure 12 sized to be used in combination with a frame 14 for a standard 8.0 inches by 10.0 inches picture.

The system 10 may further employ a Vocaliser device which is manufactured by Pyronix LTD of Great Britain for silently monitoring the enclosed confines 2. The Vocalizer has a pair of outputs which can be employed by the user in a variety of applications and discreetly positioned microphones which allow the user to listen into the enclosed confines 2 to verify the cause of the generated annunciation signal and speakers which enable the user to speak into enclosed confines 2 if necessary. It also has the ability to be simply connected to an existing phone line for dialing up to four telephone numbers, advantageously including at least one mobile number that enables the user or any other authorized person or agency to be informed immediately of an intrusion so that the appropriate action may be taken. Therefore upon receipt of generated annunciation signal, the user of the system 10 may listen into the enclosed confines 2 by entering an authorization code and verify whether the condition is a genuine intruder alarm condition requiring an appropriate action. The Vocalizer is also capable of being remotely programmed by way of the phone connection enabling the user ease of changing the operational settings.

Advantageously, the Veritec P2 sensor also incorporates the motion detector and the pressure sensor in a single housing.

The enclosure concealing means may be constructed to resemble a well known HVAC system grille 28 mounted, for example, on the wall 8 with the housing 12 being hidden behind such grille 28, as best shown in FIG. 4. The pressure sensor 60 and the motion detector 120 will be positioned in operable alignment with the louvers 29 formed within such grille 28.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A portable security system for detecting and annunciating intrusion into enclosed confines, said system comprising:
(a) a hollow enclosure having each of a predetermined shape and a predetermined size;
(b) means engageable with said hollow enclosure for concealing said hollow enclosure from direct view;
(c) a control means which is mounted within said hollow enclosure and which is operably coupled to a source capable of supplying electrical power; and
(d) a sensor means which is mounted within said hollow enclosure in electric communication with said control means, said sensor means operable to generate an intrusion signal upon detecting an intrusion condition into such enclosed confines, and whereby said control means, when being armed, is responsive to receipt of said generated intrusion signal to generate an annunciation signal annunciating said intrusion condition.

2. The system, according to claim 1, wherein said concealing means includes a picture or a painting frame which is disposed on and secured to a predetermined portion of said hollow enclosure and which is positioned to be viewed from any entry location into such enclosed confines.

3. The system, according to claim 1, wherein said concealing means includes a book or a ring binder cover which is disposed on and secured to a predetermined portion of said hollow enclosure and which is positioned to be viewed from any entry location into such enclosed confines.

4. The system, according to claim 1, wherein said concealing means includes a ventilation grille which is disposed on and secured to a predetermined portion of said hollow enclosure.

5. The system, according to claim 1, wherein said system includes an orifice which is formed in a wall portion of said hollow enclosure and wherein said sensor means is mounted within said hollow enclosure in operable alignment with said orifice.

6. The system, according to claim 1, wherein said power supply source is a power electrical outlet and said system further includes means for electrically connecting said control means to said power electrical outlet.

7. The system, according to claim 1, wherein said power supply source is at least one battery which is mounted internal to said hollow enclosure.

8. The system, according to claim 7, wherein said system includes means disposed therein for detecting a low charge condition of said at least one battery.

9. The system, according to claim 1, wherein said sensor means is a pressure sensor capable of generating said intrusion signal due to changes in air pressure within such enclosed confines and wherein said control means includes a processing means connected to receive said intrusion signal and generate said annunciation signal.

10. The system, according to claim 1, wherein said sensor means is a motion detector capable of detecting movement within such enclosed confines.

11. The system, according to claim 1, wherein said system includes means for transmitting said annunciated signal over a land line phone connection.

12. The system, according to claim 1, wherein said system includes means for generating said annunciation signal being an audible output.

13. The system, according to claim 1, wherein said system includes means for receiving remotely generated user control commands and wherein said control means is responsive to said remotely generated user control commands to control operation of said system.

14. The system, according to claim 1, wherein said system includes a remote controller which is operable by a user for remotely and selectively arming and disarming said system.

15. The system, according to claim 14, wherein said control means includes means disposed therein for wirelessly transmitting said generated annunciation signal and wherein said remote controller includes means disposed therein for receiving said wirelessly transmitted annunciation signal.

16. The system, according to claim 15, wherein said remote controller further includes means disposed therein for annunciating said received annunciation signal.

17. The system, according to claim 1, wherein said system includes means for enabling the user to listen into such interior confines from a remote location.

18. The system, according to claim 1, wherein said system includes means for annunciating at least one of arming and disarming said system.

19. A method of detecting and annunciating intrusion into enclosed confines, said method comprising the steps of:
(a) providing a sensor capable of detecting changes in air pressure within said enclosed confines and generating a respective intrusion signal;
(b) connecting said pressure sensor to a control means which when being armed is responsive to receipt of said generated intrusion signal to generate an annunciation signal annunciating said intrusion condition;
(c) positioning said sensor and said control means within a hollow enclosure;
(d) attaching an enclosure concealing means to said hollow enclosure;
(e) positioning said enclosure concealing means to conceal said hollow enclosure from a direct view when entering said confined premises; and
(f) arming said control means to generate said annunciation signal in response to receiving said intrusion signal generated by said sensor upon detecting said intrusion condition.
